(19) United States
(12) Patent Application Publication
(10) Pub. No.: US 2026/0054541 A1
(43) Pub. Date: Feb. 26, 2026

(54) OFF-ROAD VEHICLE

(71) Applicant: KAWASAKI MOTORS, LTD., Hyogo (JP)

(72) Inventor: Jumpei TOKUDA, Akashi-shi (JP)

(73) Assignee: KAWASAKI MOTORS, LTD., Hyogo (JP)

(21) Appl. No.: 19/258,688

(22) Filed: Jul. 2, 2025

(30) Foreign Application Priority Data
Aug. 20, 2024 (JP) 2024-139266

(51) Int. Cl. B60H 1/00; B60H 1/02; B60H 1/32; B60K 11/04; B60K 11/06; B60K 17/08; B60K 17/24

(52) U.S. Cl. CPC B60H 1/00571; B60H 1/00028; B60H 1/02; B60H 1/3223; B60K 11/04; B60K 11/06; B60K 17/08; B60K 17/24; B60Y 2200/20

(57) ABSTRACT

An off-road vehicle includes: a floor panel including a floor portion located in front of and under an occupant seat and a center tunnel portion that projects upward beyond the floor portion, extends in a vehicle front-rear direction, and defines a tunnel space; a propeller shaft that extends in the vehicle front-rear direction in the tunnel space and transmits driving power of a prime mover; at least one elongated body that extends in the vehicle front-rear direction in the tunnel space and introduces fluid or energy in the vehicle front-rear direction; and an air conditioning system. A cooling medium tube of the air conditioning system extends in the vehicle front-rear direction in the tunnel space and is located such that the elongated body is located between the propeller shaft and the cooling medium tube.

### CROSS-REFERENCE TO RELATED APPLICATION

This application claims priority to and the benefit of Japanese Patent Application No. 2024-139266 filed on Aug. 20, 2024, the entire disclosure of which is incorporated herein by reference.

### BACKGROUND OF THE INVENTION

### Field of the Invention

The present disclosure relates to an off-road vehicle including an air conditioner.

### Description of the Related Art

US 2023/0311619 A1 discloses an off-road vehicle including an air conditioner. In this vehicle, an internal combustion engine is located behind and under an occupant seat and under a floor panel. A propeller shaft through which rotational power output from the internal combustion engine is transmitted extends in a vehicle front-rear direction. The floor panel includes a center tunnel portion which is located at a middle in a vehicle width direction and projects upward. A tunnel space in which the propeller shaft is located is defined under the center tunnel portion. The air conditioner is located in a space located in front of a cabin. A compressor is located near the internal combustion engine and is driven by the power of the internal combustion engine. A cooling medium pipe that connects the air conditioner to the compressor extends in the front-rear direction in the tunnel space.

According to the above configuration, the cooling medium pipe extends through the tunnel space while being located adjacent to the propeller shaft that is rotating. Making the cooling medium pipe strong or covering the cooling medium pipe with a protector in case the cooling medium pipe interferes with the propeller shaft leads to an increase in the weight of the vehicle.

### SUMMARY OF THE INVENTION

An object of one aspect of the present disclosure is to, in a configuration in which a cooling medium tube for an air conditioner extends through a tunnel space together with a propeller shaft, prevent the cooling medium tube for the air conditioner from interfering with the propeller shaft while preventing an increase in the weight of a vehicle.

An off-road vehicle according to one aspect of the present disclosure includes: a vehicle body frame including a floor frame; a cabin in which an occupant seat supported by the vehicle body frame is located; a floor panel that is located at an upper side of the floor frame, defines the cabin from below, and includes a floor portion located in front of and under the occupant seat and a center tunnel portion that projects upward beyond the floor portion, extends in a vehicle front-rear direction, and defines a tunnel space; a prime mover supported by the vehicle body frame; a propeller shaft that extends in the vehicle front-rear direction in the tunnel space and transmits driving power of the prime mover; at least one elongated body that extends in the vehicle front-rear direction in the tunnel space and introduces fluid or energy in the vehicle front-rear direction; a dashboard located in front of the occupant seat; and an air conditioning system including a cooling medium tube through which a cooling medium flows. The cooling medium tube extends in the vehicle front-rear direction in the tunnel space and is located such that the elongated body is located between the propeller shaft and the cooling medium tube.

### BRIEF DESCRIPTION OF THE DRAWINGS

FIG. 1 is a left side view of an off-road vehicle according to an embodiment.

FIG. 2 is a left side view of the off-road vehicle which shows pipes of an air conditioning system and the like shown in FIG. 1.

FIG. 3 is a plan view showing a floor panel and the like of the off-road vehicle of FIG. 1.

FIG. 4A is a sectional view taken along line IVa-Iva of FIG. 3. FIG. 4B is a sectional view taken along line IVb-IVb of FIG. 3. FIG. 4C is a sectional view taken along line IVc-IVc of FIG. 3.

FIG. 5 is a diagram showing Modified Example 1 and corresponding to FIG. 4B.

FIG. 6 is a diagram showing Modified Example 2 and corresponding to FIG. 4B.

### DETAILED DESCRIPTION

Hereinafter, an embodiment will be described with reference to the drawings.

Directions in the following description are based on directions of an off-road vehicle 1 unless otherwise defined individually. A vehicle front-rear direction corresponds to a vehicle length direction, and a vehicle width direction corresponds to a vehicle left-right direction.

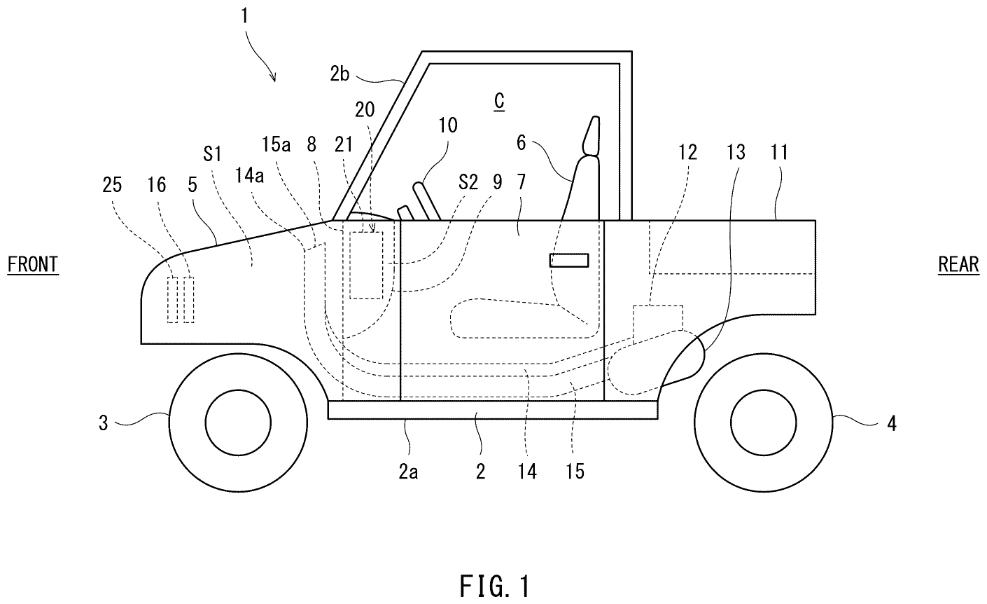

FIG. 1 is a left side view of the off-road vehicle 1 according to the embodiment. As shown in FIG. 1, the off-road vehicle 1 includes: a vehicle body frame 2; a pair of front wheels 3 that are left and right front wheels and support a front portion of the vehicle body frame 2; and a pair of rear wheels 4 that are left and right rear wheels and support a rear portion of the vehicle body frame 2. Tires for the front wheels 3 and the rear wheels 4 may be, for example, balloon tires for irregular ground traveling. The off-road vehicle 1 may also be called a utility vehicle.

The vehicle body frame 2 is a pipe frame including pipes connected to each other. The vehicle body frame 2 includes a floor frame 2a and a cabin frame 2b. The floor frame 2a supports an occupant seat 6 from below through a seat support frame. The cabin frame 2b defines a cabin C in which the occupant seat 6 is located. A front cover 5 supported by the vehicle body frame 2 is located in front of the cabin C. The front cover 5 covers, from above, a front space S1 located between the left and right front wheels 3. The front cover 5 includes a hood that opens and closes the front space S1. Side doors 7 are located at both sides of the cabin C. Each side door 7 opens and closes an entrance through which an occupant get in and out of the cabin C.

A dash panel 8 that separates the front space S1 from the cabin C is supported by the vehicle body frame 2. A dashboard 9 is located behind the dash panel 8 and in front of the occupant seat 6. The dashboard 9 includes meters. A steering wheel 10 opposed to the occupant seat 6 is located at the dashboard 9. An accommodating space S2 is defined between the dash panel 8 and the dashboard 9.

A cargo bed 11 is located behind the cabin frame 2b. The cargo bed 11 is open upward to the outside of the vehicle and defines a recessed loading space. An internal combustion engine 12 as a prime mover is located behind the occupant seat 6 and under the cargo bed 11 and is supported by the vehicle body frame 2. The internal combustion engine 12 is located behind a front end of the occupant seat 6. When the occupant seat 6 is slidable in the vehicle front-rear direction, the internal combustion engine 12 is located behind the front end of the occupant seat 6 in an entire slide region of the occupant seat 6. A continuously variable transmission 13 is located adjacent to the internal combustion engine 12. The continuously variable transmission 13 changes the rotational speed of driving power output from the internal combustion engine 12. The driving power output from the continuously variable transmission 13 is transmitted to the front wheels 3 or the rear wheels 4 or to the front wheels 3 and the rear wheels 4.

The off-road vehicle 1 includes an EG intake duct 14 and a CVT intake duct 15. The EG intake duct 14 introduces outside air to an intake port of the internal combustion engine 12 for combustion in the internal combustion engine 12, and the CVT intake duct 15 introduces the outside air to the continuously variable transmission 13 for cooling of the continuously variable transmission 13. An inlet 14a of the EG intake duct 14 and an inlet 15a of the CVT intake duct 15 are located in the front space S1. The EG intake duct 14 extends in the vehicle front-rear direction from the front space S1 to the internal combustion engine 12. The CVT intake duct 15 extends in the vehicle front-rear direction from the front space S1 to the continuously variable transmission 13.

The off-road vehicle 1 includes an air conditioning system 20. An air conditioner 21 of the air conditioning system 20 is located in front of the dashboard 9. Specifically, the air conditioner 21 is located in the accommodating space S2 defined between the dash panel 8 and the dashboard 9. A condenser 25 of the air conditioning system 20 is located in the front space S1. A radiator 16 that cools the internal combustion engine 12 is located in the front space S1.

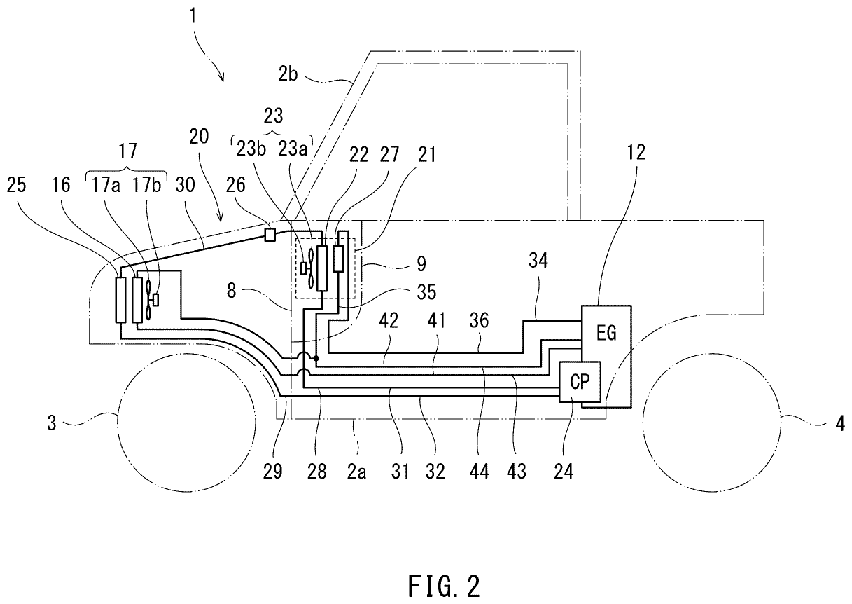

FIG. 2 is a left side view of the off-road vehicle 1 which shows pipes of the air conditioning system 20 and the like shown in FIG. 1. As shown in FIG. 2, for cooling of the cabin C, the air conditioning system 20 includes an evaporator 22, a blower 23, a compressor 24, the condenser 25, and an expansion valve 26. The air conditioner 21 located in the accommodating space S2 between the dash panel 8 and the dashboard 9 includes the evaporator 22 and the blower 23. The evaporator 22 evaporates a cooling medium to remove evaporation heat from surroundings. The blower 23 includes a fan vane 23a and an electric motor 23b that drives the fan vane 23a. The blower 23 generates air flow that makes air flow through the evaporator 22. Thus, the blower 23 sends cool air to the cabin C.

The evaporator 22 is in connection with the compressor 24 through a first cooling medium passage 28. The compressor 24 is located behind the front end of the occupant seat 6 (see FIG. 1). When the occupant seat 6 is slidable in the vehicle front-rear direction, the compressor 24 is located behind the front end of the occupant seat 6 in the entire slide region of the occupant seat 6. The compressor 24 is mechanically coupled to a crankshaft of the internal combustion engine 12 and is driven by the internal combustion engine 12. The first cooling medium passage 28 includes an internal passage of a first cooling medium tube 31 extending in the vehicle front-rear direction from the accommodating space S2 to the compressor 24.

The compressor 24 is in connection with the condenser 25 through a second cooling medium passage 29. The second cooling medium passage 29 includes an internal passage of a second cooling medium tube 32 extending in the vehicle front-rear direction from the compressor 24 to the condenser 25. The condenser 25 performs heat exchange with the outside air to lower the temperature of the cooling medium.

The condenser 25 is in connection with the evaporator 22 through a third cooling medium passage 30. The expansion valve 26 is located at the third cooling medium passage 30. The expansion valve 26 lowers the pressure and temperature of the cooling medium flowing from the condenser 25 toward the evaporator 22. The cooling medium which has reached the evaporator 22 from the expansion valve 26 is subjected to the heat exchange with the outside air at the evaporator 22 to evaporate.

In the front space S1, the radiator 16 is located behind the condenser 25. The internal combustion engine 12 is in connection with the radiator 16 through a first cooling medium passage 41. The first cooling medium passage 41 includes an internal passage of a first cooling medium pipe 43 extending in the vehicle front-rear direction from the internal combustion engine 12 to the front space S1. The cooling medium which has been increased in temperature by the internal combustion engine 12 is sent to the radiator 16 through the first cooling medium passage 41.

The radiator 16 is in connection with the internal combustion engine 12 through a second cooling medium passage 42. The second cooling medium passage 42 includes an internal passage of a second cooling medium pipe 44 extending in the vehicle front-rear direction from the front space S1 to the internal combustion engine 12. The cooling medium which has been reduced in temperature by the radiator 16 is sent to the internal combustion engine 12 through the second cooling medium passage 42.

A radiator fan 17 is located behind the radiator 16. The radiator fan 17 includes a fan vane 17a and an electric motor 17b that drives the fan vane 17a. The outside air flows through the radiator 16 by the driving of the radiator fan 17, and thus, the radiator 16 is forcibly air-cooled. Since the condenser 25 is located so as to overlap the radiator 16 from a front side of the vehicle, the outside air flows through both of the condenser 25 and the radiator 16 by the driving of the radiator fan 17.

For heating of the cabin C, the air conditioning system 20 includes a heater 27 included in the air conditioner 21. The heater 27 is in connection with the internal combustion engine 12 through a first heat medium passage 34. The first heat medium passage 34 includes an internal passage of a heat medium pipe 36 extending in the vehicle front-rear direction from the accommodating space S2 to the internal combustion engine 12. A heat medium which has been increased in temperature by the internal combustion engine 12 is sent to the heater 27 through the first heat medium passage 34.

The heater 27 releases heat to surroundings. Since the air sent by the blower 23 flows through the heater 27, warm air is sent to the cabin C. The heater 27 is in connection with the second cooling medium passage 42 through a second heat medium passage 35. To be specific, the heat medium from the heater 27 and the cooling medium from the radiator 16 join together, flow through the second cooling medium passage 42, and reach the internal combustion engine 12.

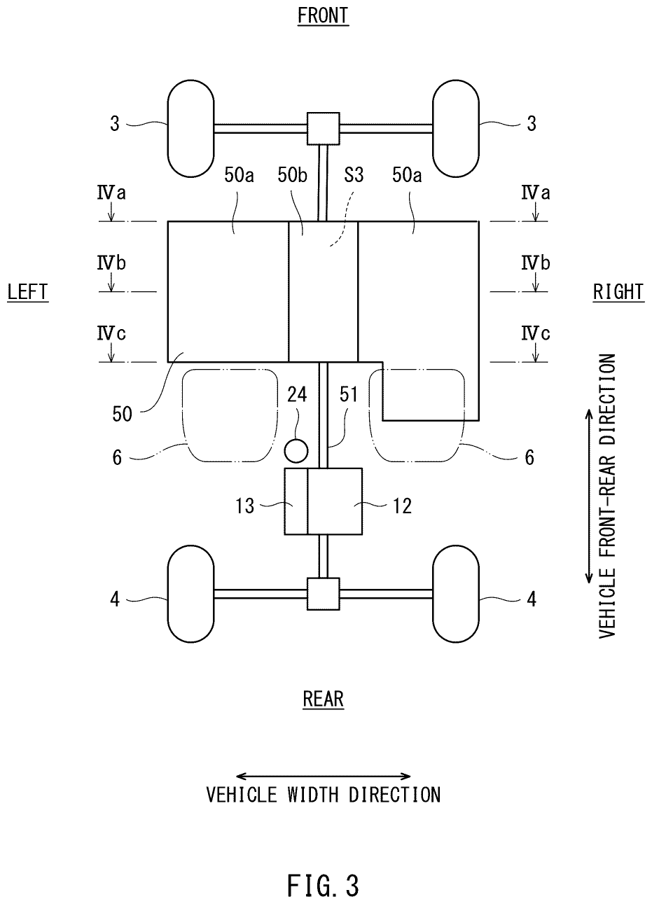

FIG. 3 is a plan view showing the floor panel and the like of the off-road vehicle 1 of FIG. 1. As shown in FIG. 3, the off-road vehicle 1 includes a floor panel 50 located at an upper side of the floor frame 2a (see FIG. 1). The floor panel 50 defines the cabin C (see FIG. 1) from below. In a plan view, the floor panel 50 extends from a region where the accommodating space S2 (see FIG. 1) exists to a region where the occupant seats 6 exist.

The floor panel 50 includes: a pair of floor portions 50a lined up in the vehicle width direction; and a center tunnel portion 50b located between the floor portions 50a in the vehicle width direction. The floor portions 50a are located at a front side and lower side of the occupant seats 6. Feet of the occupant who has sat on the occupant seat 6 are placed on an upper surface of the floor portion 50a. The center tunnel portion 50b projects upward beyond the floor portion 50a and extends in the vehicle front-rear direction.

The center tunnel portion 50b defines a tunnel space S3 which is located under the center tunnel portion 50b and extends in the vehicle front-rear direction. The tunnel space S3 is open to both sides in the vehicle front-rear direction. The driving power of the internal combustion engine 12 is changed in speed by the continuously variable transmission 13 and then transmitted to the front wheels 3 through a propeller shaft 51. The propeller shaft 51 extends through the tunnel space S3 in the vehicle front-rear direction. In FIG. 3, below-described elongated bodies 70 other than the propeller shaft 51 are not shown.

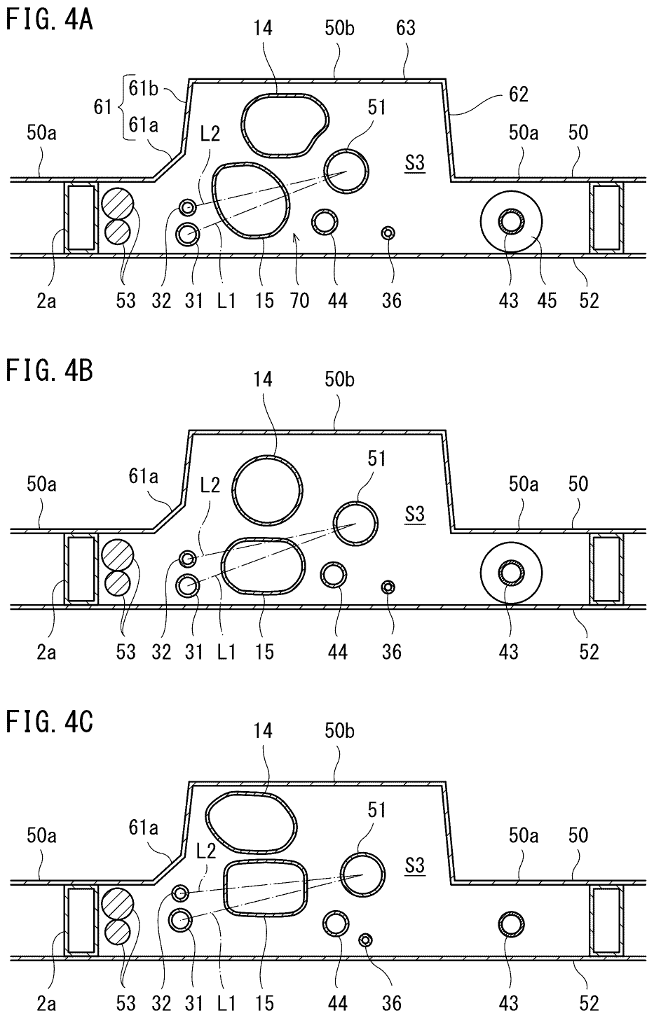

FIG. 4A is a sectional view taken along line IVa-Iva of FIG. 3. FIG. 4B is a sectional view taken along line IVb-IVb of FIG. 3. FIG. 4C is a sectional view taken along line IVc-IVc of FIG. 3. As shown in FIGS. 4A to 4C, an under panel 52 fixed to the floor frame 2a is located at a lower side of the floor frame 2a. The floor panel 50 fixed to the floor frame 2a is located at an upper side of the floor frame 2a. The floor portion 50a of the floor panel 50 extends in a horizontal direction. The upper surface of the floor portion 50a may include non-slip projections.

The center tunnel portion 50b of the floor panel 50 is located at a middle portion of the floor panel 50 in the vehicle width direction and projects upward. The tunnel space S3 is a space located between the under panel 52 and the floor panel 50 and overlapping the center tunnel portion 50b in a vertical direction.

The center tunnel portion 50b includes a pair of side wall portions 61 and 62 and an upper wall portion 63. The left side wall portion 61 projects upward from an end, which is located at a middle side in the vehicle width direction, of the floor portion 50a located at a left side of the vehicle. The right side wall portion 62 projects upward from an end, which is located at the middle side in the vehicle width direction, of the floor portion 50a located at a right side of the vehicle. The upper wall portion 63 connects upper ends of the side wall portions 61 and 62 to each other.

The side wall portion 61 includes a first portion 61a and a second portion 61b. The first portion 61a extends obliquely from the end, which is located at the middle side in the vehicle width direction, of the floor portion 50a upward and inward in the vehicle width direction, and the second portion 61b extends upward from an upper end of the first portion 61a. The first portion 61a is an inclined portion 61a whose angle to the vertical direction is larger than that of the second portion 61b.

The elongated bodies 70 that introduce fluid or energy in the vehicle front-rear direction extend at least from a front end of the floor panel 50 to a rear end of the floor panel 50 in the vehicle front-rear direction in a space between the under panel 52 and the floor panel 50. As shown in FIGS. 4A to 4C, a relative positional relation among the elongated bodies 70 stays the same in a region from a front end of the tunnel space S3 to a rear end of the tunnel space S3.

The elongated bodies 70 include the propeller shaft 51, the EG intake duct 14, the CVT intake duct 15, the first cooling medium pipe 43, the second cooling medium pipe 44, the first cooling medium tube 31, the second cooling medium tube 32, the heat medium pipe 36, and a wire harness 53.

The propeller shaft 51 introduces mechanical energy in the vehicle front-rear direction. The propeller shaft 51 includes a hollow shaft. The EG intake duct 14, the CVT intake duct 15, the first cooling medium pipe 43, the second cooling medium pipe 44, the first cooling medium tube 31, the second cooling medium tube 32, and the heat medium pipe 36 introduce the fluid in the vehicle front-rear direction. The wire harness 53 introduces electric energy in the vehicle front-rear direction.

Each of the EG intake duct 14 and the CVT intake duct 15 includes a resin duct. The first cooling medium pipe 43 and the second cooling medium pipe 44 for the radiator are metal pipes. The heat medium pipe 36 for the air conditioner is also a metal pipe. The first cooling medium tube 31 and the second cooling medium tube 32 for the air conditioner are flexible tubes, such as rubber tubes. The first cooling medium tube 31 and the second cooling medium tube 32 are examples of a flexible body. The flexible body is a body having flexibility. For example, the flexible body may be a linear body made of an elastic material such as rubber or may be a linear body, such as a metal cable, which is softly deformable. It is desirable that the flexible body be protected since the flexible body may be damaged by interference with another part.

The propeller shaft 51, the EG intake duct 14, the CVT intake duct 15, the second cooling medium pipe 44, the first cooling medium tube 31, the second cooling medium tube 32, and the heat medium pipe 36 are located in the tunnel space S3. The first cooling medium pipe 43 and the wire harness 53 are located outside the tunnel space S3 in the vehicle width direction.

The propeller shaft 51 is located in the vicinity of a sectional center of the tunnel space S3. The first cooling medium tube 31 and second cooling medium tube 32 of the air conditioning system 20 are located away from the propeller shaft 51 in the vehicle width direction. The first cooling medium tube 31 and the second cooling medium tube 32 are located at an end portion of the tunnel space S3 in the vehicle width direction. Specifically, the first cooling medium tube 31 and the second cooling medium tube 32 are located vertically under the inclined portion 61a of the side wall portion 61 of the center tunnel portion 50b. The first cooling medium tube 31 and the second cooling medium tube 32 are lined up in the vertical direction. The first cooling medium tube 31 and the second cooling medium tube 32 are coupled to each other by clamps located at intervals in a longitudinal direction of the first cooling medium tube 31 and the second cooling medium tube 32.

The EG intake duct 14 and the CVT intake duct 15 are lined up in the vertical direction. To be specific, the EG intake duct 14 and the CVT intake duct 15 overlap each other in the vertical direction. In the present embodiment, the EG intake duct 14 is located above the CVT intake duct 15. However, an upper-lower positional relation between the EG intake duct 14 and the CVT intake duct 15 may be reversed.

A minimum passage sectional area of a portion of the EG intake duct 14 which is located in the tunnel space S3 is larger than each of a maximum passage sectional area of a portion of the first cooling medium tube 31 which is located in the tunnel space S3 and a maximum passage sectional area of a portion of the second cooling medium tube 32 which is located in the tunnel space S3. Similarly, a minimum passage sectional area of a portion of the CVT intake duct 15 which is located in the tunnel space S3 is larger than each of a maximum passage sectional area of a portion of the first cooling medium tube 31 which is located in the tunnel space S3 and a maximum passage sectional area of a portion of the second cooling medium tube 32 which is located in the tunnel space S3.

In the tunnel space S3, the EG intake duct 14 and the CVT intake duct 15 are located between the first cooling medium tube 31 and the propeller shaft 51 in the vehicle width direction. In the tunnel space S3, the EG intake duct 14 and the CVT intake duct 15 are located between the second cooling medium tube 32 and the propeller shaft 51 in the vehicle width direction.

In the tunnel space S3, the CVT intake duct 15 is located between the first cooling medium tube 31 and the propeller shaft 51. In the tunnel space S3, the CVT intake duct 15 is located between the second cooling medium tube 32 and the propeller shaft 51. In the tunnel space S3, the first cooling medium tube 31 and the second cooling medium tube 32 overlap the CVT intake duct 15 when viewed in the vehicle width direction. In the tunnel space S3, the propeller shaft 51 overlaps at least one of the EG intake duct 14 or the CVT intake duct 15 when viewed in the vehicle width direction. A minimum distance between the EG intake duct 14 and the CVT intake duct 15 in the tunnel space S3 is smaller than each of an outer diameter of the first cooling medium tube 31 and an outer diameter of the second cooling medium tube 32.

In at least part of a region from the front end of the tunnel space S3 to the rear end of the tunnel space S3, a virtual line that connects an arbitrary point of an outer surface of the first cooling medium tube 31 and an arbitrary point of an outer surface of the propeller shaft 51 in a vertical section intersects with the CVT intake duct 15. In the present embodiment, in at least part of the region from the front end of the tunnel space S3 to the rear end of the tunnel space S3, a virtual line L1 that connects the sectional center of the first cooling medium tube 31 and the sectional center of the propeller shaft 51 in a vertical sectional view intersects with the CVT intake duct 15. As one example, in the entire region from the front end of the tunnel space S3 to the rear end of the tunnel space S3, the virtual line L1 intersects with the CVT intake duct 15.

In at least part of the region from the front end of the tunnel space S3 to the rear end of the tunnel space S3, a virtual line that connects an arbitrary point of an outer surface of the second cooling medium tube 32 and an arbitrary point of the outer surface of the propeller shaft 51 in a vertical section intersects with the CVT intake duct 15. In the present embodiment, in at least part of the region from the front end of the tunnel space S3 to the rear end of the tunnel space S3, a virtual line L2 that connects the sectional center of the second cooling medium tube 32 and the sectional center of the propeller shaft 51 in a vertical sectional view intersects with the CVT intake duct 15. As one example, in the entire region from the front end of the tunnel space S3 to the rear end of the tunnel space S3, the virtual line L2 intersects with the CVT intake duct 15.

In the tunnel space S3, the second cooling medium pipe 44 for the radiator 16 is located between the first cooling medium tube 31 and the propeller shaft 51 in the vehicle width direction. In the tunnel space S3, the second cooling medium pipe 44 is located between the second cooling medium tube 32 and the propeller shaft 51 in the vehicle width direction. In the tunnel space S3, the heat medium pipe 36 is located further away from the first cooling medium tube 31 and the second cooling medium tube 32 in the vehicle width direction than the second cooling medium pipe 44 is. In the tunnel space S3, the EG intake duct 14 and the CVT intake duct 15 are located between a group of the second cooling medium pipe 44 and the heat medium pipe 36 and a group of the first cooling medium tube 31 and the second cooling medium tube 32 in the vehicle width direction. In the tunnel space S3, the second cooling medium pipe 44 and the heat medium pipe 36 are located under the propeller shaft 51.

The first cooling medium pipe 43 for the radiator 16 is located vertically under the right floor portion 50a. The first cooling medium pipe 43 is covered with a thermal insulator 45. The wire harness 53 is located vertically under the left floor portion 50a. The wire harness 53 is one example of a flexible body. The wire harness 53 is positioned with respect to the floor frame 2a by clamps located at intervals in a longitudinal direction of the wire harness 53.

The EG intake duct 14, the CVT intake duct 15, the first cooling medium tube 31, and the second cooling medium tube 32 are located between the wire harness 53 and the heat medium pipe 36 in the vehicle width direction. The EG intake duct 14, the CVT intake duct 15, the first cooling medium tube 31, and the second cooling medium tube 32 are located between the wire harness 53 and the second cooling medium pipe 44 in the vehicle width direction.

According to the above-described configuration, the CVT intake duct 15 also plays a role of preventing the cooling medium tubes 31 and 32 for the air conditioner from interfering with the propeller shaft 51. Therefore, in the configuration in which the cooling medium tubes 31 and 32 for the air conditioner extend through the tunnel space S3 together with the propeller shaft 51, the cooling medium tubes 31 and 32 can be prevented from interfering with the propeller shaft 51 while preventing an increase in the weight of the vehicle.

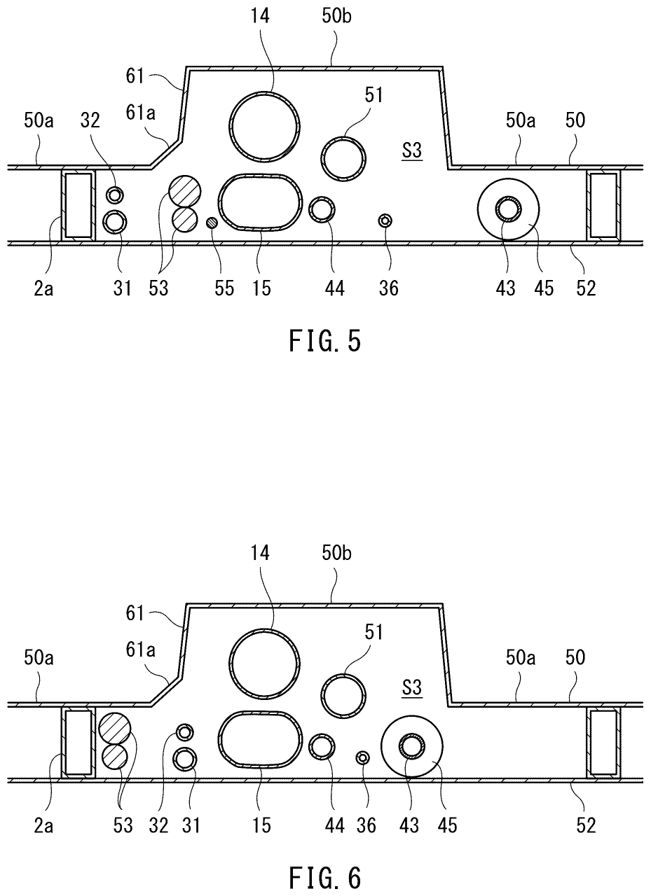

FIG. 5 is a diagram showing Modified Example 1 and corresponding to FIG. 4B.

The same reference signs are used for the same components as the above embodiment, and the repetition of the same explanation is avoided. As shown in FIG. 5, Modified Example 1 is different from the above embodiment regarding the positions of the first cooling medium tube 31, the second cooling medium tube 32, and the wire harness 53 and the presence of a shift cable 55. The wire harness 53 and the shift cable 55 are located in the tunnel space S3. The first cooling medium tube 31 and the second cooling medium tube 32 are located outside the tunnel space S3 in the vehicle width direction.

The wire harness 53 is located at an end portion of the tunnel space S3 in the vehicle width direction. Specifically, the wire harness 53 is located vertically under the inclined portion 61a of the side wall portion 61 of the center tunnel portion 50b. The shift cable 55 extends in the vehicle front-rear direction in the tunnel space S3. The shift cable 55 is a cable through which power for a speed change operation of a gear transmission is transmitted when the off-road vehicle 1 includes the gear transmission. The shift cable 55 is one example of the flexible body and introduces mechanical energy in the vehicle front-rear direction. The shift cable 55 may be omitted.

The EG intake duct 14 and the CVT intake duct 15 are located between the wire harness 53 and the propeller shaft 51 in the vehicle width direction. The EG intake duct 14 and the CVT intake duct 15 are located between the shift cable 55 and the propeller shaft 51 in the vehicle width direction. The CVT intake duct 15 is located between the wire harness 53 and the propeller shaft 51. The CVT intake duct 15 is located between the shift cable 55 and the propeller shaft 51. The wire harness 53 and the shift cable 55 overlap the CVT intake duct 15 when viewed in the vehicle width direction.

According to this configuration, the CVT intake duct 15 can also play a role of preventing the wire harness 53 and the shift cable 55 from interfering with the propeller shaft 51. Since the other components are the same as those in the above embodiment, explanations thereof are omitted.

FIG. 6 is a diagram showing Modified Example 2 and corresponding to FIG. 4B. The same reference signs are used for the same components as the above embodiment, and the repetition of the same explanation is avoided. As shown in FIG. 6, in Modified Example 2, all of fluid pipes extending in the vehicle front-rear direction from a region located in front of the dashboard 9 to a region located behind the front end of the occupant seat 6 in the off-road vehicle 1 extend through the tunnel space S3. The first cooling medium tube 31, the second cooling medium tube 32, the EG intake duct 14, the CVT intake duct 15, the heat medium pipe 36, the first cooling medium pipe 43, and the second cooling medium pipe 44 are all of the fluid pipes extending in the vehicle front-rear direction from the region located in front of the dashboard 9 to the region located behind the front end of the occupant seat 6 in the off-road vehicle 1. Thus, the tunnel space S3 can be effectively utilized while preventing the interference between the cooling medium tubes 31 and 32 and the propeller shaft 51. Since the other components are the same as those in the above embodiment, explanations thereof are omitted.

The technology of the present disclosure is not limited to the above embodiment. For example, at least one of the EG intake duct 14 or the CVT intake duct 15 may not be located between a group of the cooling medium tubes 31 and 32 for the air conditioner and the propeller shaft 51 in the vehicle width direction. The second cooling medium pipe 44 and the heat medium pipe 36 may be located between the group of the cooling medium tubes 31 and 32 for the air conditioner and the propeller shaft 51.

### Aspects

The above embodiment is a specific example of the following aspects.

### First Aspect

An off-road vehicle including:
a vehicle body frame including a floor frame;
a cabin in which an occupant seat supported by the vehicle body frame is located;
a floor panel that is located at an upper side of the floor frame, defines the cabin from below, and includes
   a floor portion located in front of and under the occupant seat and
   a center tunnel portion that projects upward beyond the floor portion, extends in a vehicle front-rear direction, and defines a tunnel space;
a prime mover supported by the vehicle body frame;
a propeller shaft that extends in the vehicle front-rear direction in the tunnel space and transmits driving power of the prime mover;
at least one elongated body that extends in the vehicle front-rear direction in the tunnel space and introduces fluid or energy in the vehicle front-rear direction;
a dashboard located in front of the occupant seat; and
an air conditioning system including a cooling medium tube through which a cooling medium flows, wherein
the cooling medium tube extends in the vehicle front-rear direction in the tunnel space and is located such that the elongated body is located between the propeller shaft and the cooling medium tube.

According to this configuration, the elongated body that introduces the fluid or the energy in the vehicle front-rear direction also plays a role of preventing the cooling medium tube for the air conditioner from interfering with the propeller shaft. Therefore, in the configuration in which the cooling medium tube for the air conditioner extends through the tunnel space together with the propeller shaft, the cooling medium tube for the air conditioner can be prevented from interfering with the propeller shaft while preventing an increase in the weight of the vehicle.

### Second Aspect

The off-road vehicle according to the first aspect, wherein:
the air conditioning system further includes
   an air conditioner that includes an evaporator and a blower and is located in front of the dashboard and
   a compressor located behind a front end of the occupant seat; and
the cooling medium tube connects the evaporator to the compressor.

According to this configuration, the cooling medium tube that connects the evaporator and the compressor can be prevented from interfering with the propeller shaft.

### Third Aspect

The off-road vehicle according to the first or second aspect, wherein the at least one elongated body includes an intake duct.

According to this configuration, the cooling medium tube for the air conditioner can be prevented from interfering with the propeller shaft by the intake duct that introduces the intake air in the vehicle front-rear direction.

### Fourth Aspect

The off-road vehicle according to the third aspect, wherein:
the prime mover includes an internal combustion engine; and
the intake duct includes an EG intake duct that introduces intake air to the internal combustion engine for combustion in the internal combustion engine.

According to this configuration, the EG intake duct can be utilized to prevent the interference between the propeller shaft and the cooling medium tube.

### Fifth Aspect

The off-road vehicle according to the third or fourth aspect, further including a continuously variable transmission that changes speed of driving power of the prime mover, wherein
the intake duct includes a CVT intake duct that introduces intake air to the continuously variable transmission for cooling of the continuously variable transmission.

According to this configuration, the CVT intake duct can be utilized to prevent the interference between the propeller shaft and the cooling medium tube.

### Sixth Aspect

The off-road vehicle according to any one of the third to fifth aspects, wherein a minimum passage sectional area of a portion of the intake duct which is located in the tunnel space is larger than a maximum passage sectional area of a portion of the cooling medium tube which is located in the tunnel space.

According to this configuration, the interference between the propeller shaft and the cooling medium tube can be adequately prevented by the intake duct.

### Seventh Aspect

The off-road vehicle according to any one of the first to sixth aspects, further including a continuously variable transmission that changes speed of driving power of the prime mover, wherein:
the prime mover includes an internal combustion engine;
the at least one elongated body includes at least one of an EG intake duct that introduces intake air to the internal combustion engine for combustion in the internal combustion engine or a CVT intake duct that introduces the intake air to the continuously variable transmission for cooling of the continuously variable transmission;
the cooling medium tube is located away from the propeller shaft in a vehicle width direction; and
the EG intake duct and the CVT intake duct are lined up in a vertical direction while being located between the cooling medium tube and the propeller shaft in the vehicle width direction.

According to this configuration, the interference between the cooling medium tube and the propeller shaft can be satisfactorily prevented by the EG intake duct and the CVT intake duct which are lined up in the vertical direction.

### Eighth Aspect

The off-road vehicle according to any one of the first to seventh aspects, further including a radiator located in a front space located in front of the cabin, wherein:
the prime mover includes an internal combustion engine; and
the at least one elongated body includes a cooling medium pipe which connects the radiator to the internal combustion engine and through which the cooling medium flows.

According to this configuration, the cooling medium tube for the air conditioner can be prevented from interfering with the propeller shaft by the cooling medium pipe that connects the radiator and the internal combustion engine.

### Ninth Aspect

The off-road vehicle according to the eighth aspect, wherein the cooling medium pipe includes a metal pipe.

According to this configuration, the cooling medium tube for the air conditioner can be satisfactorily prevented from interfering with the propeller shaft by the cooling medium pipe that cools the internal combustion engine.

### Tenth Aspect The off-road vehicle according to any one of the first to ninth aspects, wherein the cooling medium tube includes a flexible tube.

According to this configuration, the cooling medium tube for the air conditioner can be easily handled.

### Eleventh Aspect

The off-road vehicle according to any one of the first to tenth aspects, wherein all of fluid pipes which are included in the off-road vehicle and extend in the vehicle front-rear direction from a region located in front of the dashboard to a region located behind a front end of the occupant seat extend through the tunnel space.

According to this configuration, the tunnel space can be effectively utilized while preventing the interference between the cooling medium tube and the propeller shaft.

### Twelfth Aspect

The off-road vehicle according to any one of the first to eleventh aspects, wherein the cooling medium tube is located at an end portion of the tunnel space in a vehicle width direction.

According to this configuration, the cooling medium tube can be located away from the propeller shaft.

### Thirteenth Aspect

The off-road vehicle according to the twelfth aspect, wherein:
the center tunnel portion includes a side wall portion projecting upward from an end of the floor portion in the vehicle width direction;
the side wall portion includes an inclined portion that extends obliquely from the end of the floor portion upward and inward in the vehicle width direction; and
the cooling medium tube is located vertically under the inclined portion.

According to this configuration, the cooling medium tube can be located in the tunnel space while being located adequately away from the propeller shaft.

### Fourth Aspect

The off-road vehicle according to any one of the first to thirteenth aspects, wherein:
the prime mover includes an internal combustion engine; and
the air conditioning system includes a heater located in front of the dashboard;
the off-road vehicle further including:
a radiator located in a front space located in front of the cabin;
a cooling medium pipe which connects the radiator to the internal combustion engine and extends in the vehicle front-rear direction in the tunnel space and through which the cooling medium flows;
a heat medium pipe that connects the heater to the internal combustion engine and extends in the vehicle front-rear direction in the tunnel space and through which a heat medium flows; and
a pipe that extends in the vehicle front-rear direction in the tunnel space, introduces the fluid in the vehicle front-rear direction, and is located between the cooling medium tube and at least one of the cooling medium pipe or the heat medium pipe.

According to this configuration, the heat transfer from the cooling medium pipe or the heat medium pipe to the cooling medium tube can be suppressed by the pipe.

### Fifteenth Aspect

An off-road vehicle including:
a vehicle body frame including a floor frame;
a cabin in which an occupant seat supported by the vehicle body frame is located;
a floor panel that is located at an upper side of the floor frame, defines the cabin from below, and includes
   a floor portion located in front of and under the occupant seat and
   a center tunnel portion that projects upward beyond the floor portion, extends in a vehicle front-rear direction, and defines a tunnel space;
a prime mover supported by the vehicle body frame;
a propeller shaft that extends in the vehicle front-rear direction in the tunnel space and transmits driving power of the prime mover;
an intake duct extending in the vehicle front-rear direction in the tunnel space; and
at least one flexible body that extends in the vehicle front-rear direction in the tunnel space, introduces fluid or energy in the vehicle front-rear direction, and is located such that the intake duct is located between the flexible body and the propeller shaft.

According to this configuration, the intake duct also plays a role of preventing the flexible body, which introduces the fluid or the energy in the vehicle front-rear direction, from interfering with the propeller shaft. Therefore, in the configuration in which the flexible body extends through the tunnel space together with the propeller shaft, the flexible body can be prevented from interfering with the propeller shaft while preventing an increase in the weight of the vehicle.

### Sixteenth Aspect

The off-road vehicle according to the fifteenth aspect, wherein the at least one flexible body includes a cooling medium tube of an air conditioning system, a wire harness, or a cable.

According to this configuration, the cooling medium tube, the wire harness, or the cable can be prevented from interfering with the propeller shaft.

What is claimed is:

1. An off-road vehicle comprising:
a vehicle body frame including a floor frame;
a cabin in which an occupant seat supported by the vehicle body frame is located;
a floor panel that is located at an upper side of the floor frame, defines the cabin from below, and includes
a floor portion located in front of and under the occupant seat and
a center tunnel portion that projects upward beyond the floor portion, extends in a vehicle front-rear direction, and defines a tunnel space;
a prime mover supported by the vehicle body frame;
a propeller shaft that extends in the vehicle front-rear direction in the tunnel space and transmits driving power of the prime mover;
at least one elongated body that extends in the vehicle front-rear direction in the tunnel space and introduces fluid or energy in the vehicle front-rear direction;
a dashboard located in front of the occupant seat; and
an air conditioning system including a cooling medium tube through which a cooling medium flows, wherein
the cooling medium tube extends in the vehicle front-rear direction in the tunnel space and is located such that the elongated body is located between the propeller shaft and the cooling medium tube.

2. The off-road vehicle according to claim 1, wherein:
the air conditioning system further includes
an air conditioner that includes an evaporator and a blower and is located in front of the dashboard and
a compressor located behind a front end of the occupant seat; and
the cooling medium tube connects the evaporator to the compressor.

3. The off-road vehicle according to claim 1, wherein the at least one elongated body includes an intake duct.

4. The off-road vehicle according to claim 3, wherein:
the prime mover includes an internal combustion engine; and
the intake duct includes an EG intake duct that introduces intake air to the internal combustion engine for combustion in the internal combustion engine.

5. The off-road vehicle according to claim 3, further comprising a continuously variable transmission that changes speed of driving power of the prime mover, wherein
the intake duct includes a CVT intake duct that introduces intake air to the continuously variable transmission for cooling of the continuously variable transmission.

6. The off-road vehicle according to claim 3, wherein a minimum passage sectional area of a portion of the intake duct which is located in the tunnel space is larger than a maximum passage sectional area of a portion of the cooling medium tube which is located in the tunnel space.

7. The off-road vehicle according to claim 1, further comprising a continuously variable transmission that changes speed of driving power of the prime mover, wherein:
the prime mover includes an internal combustion engine;
the at least one elongated body includes at least one of an EG intake duct that introduces intake air to the internal combustion engine for combustion in the internal combustion engine or a CVT intake duct that introduces the intake air to the continuously variable transmission for cooling of the continuously variable transmission;
the cooling medium tube is located away from the propeller shaft in a vehicle width direction; and
the EG intake duct and the CVT intake duct are lined up in a vertical direction while being located between the cooling medium tube and the propeller shaft in the vehicle width direction.

8. The off-road vehicle according to claim 1, further comprising a radiator located in a front space located in front of the cabin, wherein:
the prime mover includes an internal combustion engine; and
the at least one elongated body includes a cooling medium pipe which connects the radiator to the internal combustion engine and through which the cooling medium flows.

9. The off-road vehicle according to claim 8, wherein the cooling medium pipe includes a metal pipe.

10. The off-road vehicle according to claim 1, wherein the cooling medium tube includes a flexible tube.

11. The off-road vehicle according to claim 1, wherein all of fluid pipes which are included in the off-road vehicle and extend in the vehicle front-rear direction from a region located in front of the dashboard to a region located behind a front end of the occupant seat extend through the tunnel space.

12. The off-road vehicle according to claim 1, wherein the cooling medium tube is located at an end portion of the tunnel space in a vehicle width direction.

13. The off-road vehicle according to claim 12, wherein:
the center tunnel portion includes a side wall portion projecting upward from an end of the floor portion in the vehicle width direction;
the side wall portion includes an inclined portion that extends obliquely from the end of the floor portion upward and inward in the vehicle width direction; and
the cooling medium tube is located vertically under the inclined portion.

14. The off-road vehicle according to claim 1, wherein:
the prime mover includes an internal combustion engine; and
the air conditioning system includes a heater located in front of the dashboard;
the off-road vehicle further comprising:
a radiator located in a front space located in front of the cabin;
a cooling medium pipe which connects the radiator to the internal combustion engine and extends in the vehicle front-rear direction in the tunnel space and through which the cooling medium flows;
a heat medium pipe that connects the heater to the internal combustion engine and extends in the vehicle front-rear direction in the tunnel space and through which a heat medium flows; and
a pipe that extends in the vehicle front-rear direction in the tunnel space, introduces the fluid in the vehicle front-rear direction, and is located between the cooling medium tube and at least one of the cooling medium pipe or the heat medium pipe.

15. An off-road vehicle comprising:
a vehicle body frame including a floor frame;
a cabin in which an occupant seat supported by the vehicle body frame is located;
a floor panel that is located at an upper side of the floor frame, defines the cabin from below, and includes
a floor portion located in front of and under the occupant seat and
a center tunnel portion that projects upward beyond the floor portion, extends in a vehicle front-rear direction, and defines a tunnel space;
a prime mover supported by the vehicle body frame;
a propeller shaft that extends in the vehicle front-rear direction in the tunnel space and transmits driving power of the prime mover;
an intake duct extending in the vehicle front-rear direction in the tunnel space; and
at least one flexible body that extends in the vehicle front-rear direction in the tunnel space, introduces fluid or energy in the vehicle front-rear direction, and is located such that the intake duct is located between the flexible body and the propeller shaft.

16. The off-road vehicle according to claim 15, wherein the at least one flexible body includes a cooling medium tube of an air conditioning system, a wire harness, or a cable.
